(19) United States
(12) Patent Application Publication
(10) Pub. No.: US 2009/0320949 A1
(43) Pub. Date: Dec. 31, 2009

(54) SEPARATING ELECTRICAL CONTROL WATER FAUCET

(76) Inventor: Tzu-Yi LIAO, Sanchong City (TW)

Correspondence Address: BIRCH STEWART KOLASCH & BIRCH, PO BOX 747, FALLS CHURCH, VA, 22040-0747, US

(21) Appl. No.: 12/146,163

(22) Filed: Jun. 25, 2008

(51) Int. Cl. F16K 21/00

(52) U.S. Cl. 137/801

(57) ABSTRACT

A separating electrical control water faucet is provided. The separating electrical control water faucet employs a water pipe in a hollow body of the faucet, and an electrical control module on an upper end of the body at a position higher than the water pipe, in which the electrical control module is positioned at a position higher than the water pipe. In such a way, even when a leakage occurs at the water pipe, the water leakage would not damage the electrical components or circuits of the electrical control module. A lifespan of the electrical control water faucet is thus prolonged.

### BACKGROUND OF THE INVENTION

1. Field of the Invention

The present invention relates generally to an electrical control water faucet controlling water conditions including feeding water, stopping feeding water, acidity and alkalinity, and temperature, or the like in an electrical manner.

2. The Prior Arts

Presently, electrical control water faucets are mostly used in electrical water supplying products or systems such as water purifiers, and electric hot water pots. When a user operates such an electrical control water faucet, an electrical signal is transmitted to a controller by a preset circuit or program, so as to instruct a feeding pump to draw water and feed the water out from an outlet of the water faucet. When the operation is dismissed, the water feeding is stopped. Such an electrical water faucet can be advantageously modified to include multiple functions (e.g. temperature setting, flow control, and acidity and alkalinity adjusting) by employing additional equipment, or changing the circuit or the control program, so as to achieve multiple additional values.

A typical electrical control water control generally includes a body, a water pipe, and an electrical control module. The body is a hollow tubular member including a conduit extending at a sidewall thereof. The water pipe is disposed through the body and the conduit. One end of the water pipe extends to an outlet of the conduit serving as a water outlet. Another end of the water pipe is connected to the feeding pump. The electrical control module is disposed at a sidewall of the body. The electrical control module includes an operation panel, and transmission lines. The operation panel is exposed at a surface of the body, while the transmission lines are disposed inside the body and electrically connected to an electrical control unit of the feeding pump. When the user presses a feeding key of the operation panel, the preset circuit or program transmits a signal for instructing the feeding pump to draw water, so that the drawn water flows out from the conduit of the body via the water pipe. Or otherwise, when the operation is terminated, the water stops from flowing out from the conduit.

The electrical control module of the conventional electrical control water faucet is disposed at the body of the water faucet, and is positioned at the sidewall of the body with a height lower than the conduit. In such a way, once a leakage occurs at the water pipe, the water leakage is likely to damage electrical components or circuits of the electrical control module. In other words, a damage of the water pipe may cause a damage to the circuit, which brings more loss and demands for a higher maintenance fee for the consumer.

### SUMMARY OF THE INVENTION

A primary objective of the present invention is to provide a solution of the shortcoming of the conventional electrical control water faucet, which is once a leakage occurs at the water pipe, the water leakage is likely to damage electrical components or circuits of the electrical control module.

The present invention is featured in that a water pipe and an electrical control module of an electrical control faucet are separately disposed, and the electrical control module is disposed at a position higher than the water pipe. According to this design, once a leakage occurs at the water pipe, the water leakage would not damage the electrical components or circuits of the electrical control module.

The present invention is further featured in that the electrical control module is disposed independent from a body of the faucet, and is independently protected, for further preventing water from damaging the electrical module.

For achieving the foregoing objective and features, the present invention employs a water pipe in a hollow body of the faucet and an electrical control module on an upper end of the body at a position higher than the water pipe, wherein the electrical control module is disposed independent from the water pipe. In such a way, even when there is a water leakage occurred of the water pipe in the body, the water leakage does not affect the electrical control module.

### BRIEF DESCRIPTION OF THE DRAWINGS

The present invention will be apparent to those skilled in the art by reading the following detailed description of a preferred embodiment thereof, with reference to the attached drawings, in which.

FIG. 1 is a perspective view of an electrical control water faucet according to an embodiment of the present invention;

FIG. 2 is an exploded perspective view of critical components of the electrical control water faucet according to an embodiment of the present invention;

FIG. 3 is a front view of the electrical control water faucet of the present invention; and

FIG. 4 is a cross-sectional view of the electrical control water faucet taken along line IV-IV of FIG. 3 illustrating an inner structure of the electrical control water faucet of the present invention.

### DETAILED DESCRIPTION OF THE PREFERRED EMBODIMENT

The accompanying drawings are included to provide a further understanding of the invention, and are incorporated in and constitute a part of this specification. The drawings illustrate embodiments of the invention and, together with the description, serve to explain the principles of the invention.

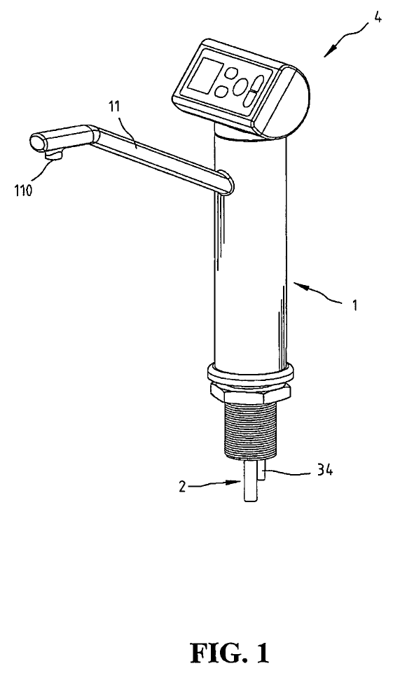

FIG. 1 is a perspective view of an electrical control water faucet according to an embodiment of the present invention. Referring to FIG. 1, it illustrates a separating electrical control water faucet. The separating electrical control water faucet includes a body 1, and a conduit extendingly disposed at a side wall of the body 1, the conduit having a conduit opening 110. A water pipe 2 and a transmission line 34 are disposed through the body 1. The water pipe 2 is also disposed through the conduit 11, so that a water flow can flow out from the conduit 11. A housing 4 is equipped at an upper end of the body 1. An electrical control module 3 is accommodated inside the housing 4. The transmission line 34 is electrically connected with the electrical control module 3.

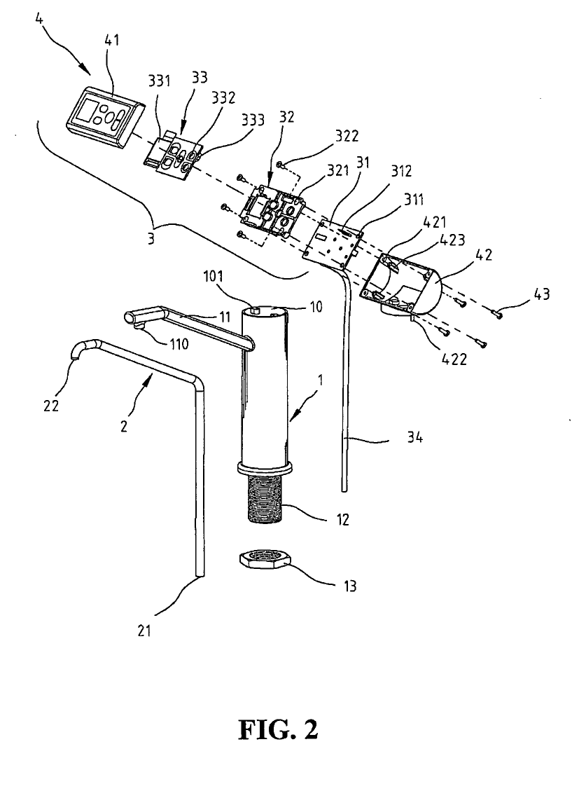

Referring to FIG. 2, according to a preferred embodiment of the present invention, the separating electrical control water faucet includes the body 1, the water pipe 2, and the electrical control module 3. The body 1 is a hollow tube having an inner space 10. The body 1 is configured with a plurality of fixing holes 101 at an upper side of the inner space 10. The body 1 is configured with an external thread 12 at a lower end thereof. The body 1 is integrally configured with a conduit 11 extending at a sidewall thereof at adjacent to the upper end of the body 1. The conduit 11 has a conduit opening 110 configured downwardly.

The water pipe 2 is a pipe member adapted for delivering water. A lower end of the water pipe 2 is a water inlet 21, and an upper end of the water pipe 2 is a water outlet 22. The water pipe 2 is formed with a shape corresponding to the conduit 11 of the body 1. The water pipe is upwardly inserted through the inner space 10 and the conduit 1 of the body 1, so that the water outlet 22 is positioned corresponding to the conduit opening 110.

Preferably, the electrical control module 3 further includes a circuit substrate 31, a clapboard 32, and a touch control panel 33. The circuit substrate 31 is configured with a plurality of first through holes 311, and a connection plug 312. The electrical substrate 31 is electrically connected to an end of the transmission line 34. The transmission line 34 is provided for transmitting electrical signals. The clapboard 32 includes a plurality of second through holes 321 corresponding to the first through holes 311. The touch control panel 33 is an optoelectronic means including a liquid crystal display panel (LCD) and a plurality of keys 332. The keys 332 are provided for controlling water flow rate, water acidity and alkalinity, and water temperature, or the like. Values of the water flow rate, the water acidity and alkalinity, and the water temperature are displayed on the LCD panel 331. The touch control penal 33 further includes a plug receptacle 333 corresponding to the plug 312 of the circuit base 31.

According to an aspect of the present invention, the separating electrical control water faucet further includes a housing 4 for accommodating the electrical control module 3 to provide an optimal protection to the electrical module 3. The housing 4 includes a front housing member 41 and a rear housing member 42. The rear housing member 42 is configured with a plurality of first fixing poles 421 and a plurality of second fixing poles 423 inside the housing 4, and a plurality of second fixing poles 422 at a bottom of an outside of the rear housing member 42.

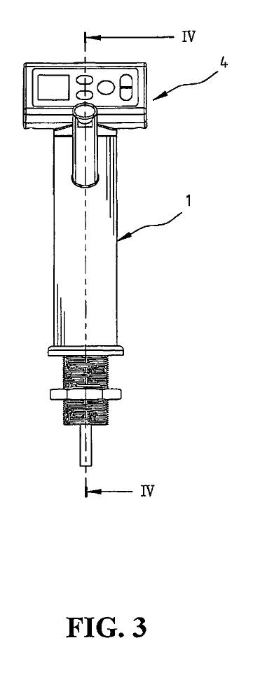

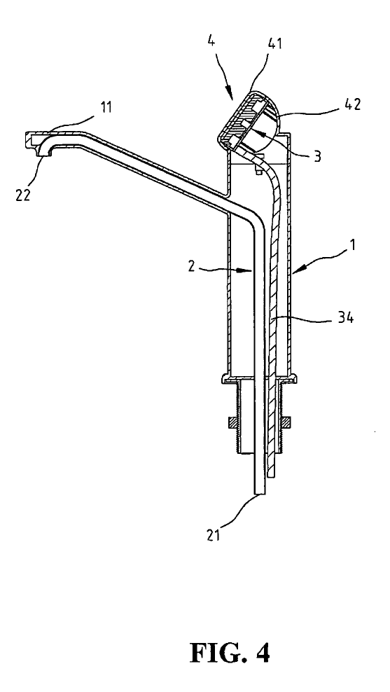

In assembling the aforementioned components, the water pipe 2 is disposed though the inner space 10 and the conduit 11 of the body 1, so that the water outlet 22 of the water pipe 2 is positioned corresponding to the conduit opening 110, and the water inlet 21 of the water pipe 2 is connected to a water feeding pump (not shown in the drawings). The external thread 12 at the lower end of the body 1 is equipped through an opening of a counter or other furniture, and then screwed with a screw cap for fixing the body 1. The electrical control module 3 is assembled together with the housing 4 at the upper end of the body 1. Specifically, the second fixing poles 422 of the rear housing member 42 are aligned to and then inserted in the fixing holes 101 of the body 1, so that the rear housing member 42 is fixed to the upper end of the body 1. Then, the electrical control module 3 is fixed by fitting screw bolts 322 sequentially through the second through holes 321 the clapboard 32 and the first through holes 311 of the circuit substrate 31; then locking in the third fixing poles 423 of the rear housing member 42, assembling the touch control panel 33 on the clapboard 32; and finally inserting fixing screw bolts 43 through the first fixing poles 421 from a rear side of the rear housing member 42 and then locking the fixing screw bolts 43 to the front housing member 41, thus accommodating the electrical control module 3 inside the housing 4, and at the same time fixing the electrical control module 3 together with the housing 4 to the body 1. One end of the transmission line 34 of the circuit substrate 31 is electrically connected to a control unit (not shown in the drawings) of the water feeding pump. After assembling, the present invention is featured in that the electrical control module 3 is disposed at a position higher than the water pipe 2. Even further, the electrical control module 3 is disposed outside and over the body 1, and is protected by the housing 4 (as shown in FIGS. 3 and 4). As such, even when the water pipe 2 is broken, the water leakage would not affect the electrical control module 3 or cause any damage thereto.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A separating electrical control water faucet, comprising:
a body having an inner space;
a water pipe disposed inside the inner space of the body; and
an electrical control module controlling water conditions comprising feeding water or not, and acidity and alkalinity,
wherein the electrical control module is disposed at an upper end of the body and is equipped at a position higher than the water pipe.

2. The separating electrical control water faucet according to claim 1, wherein the body further comprises a housing disposed at the upper end of the body, the electrical control module being accommodated in the housing, and the electrical control module being connected with a transmission line extending inside the body.

3. The separating electrical control water faucet according to claim 1, wherein the electrical control module further comprises a touch control panel having a liquid crystal display (LCD) panel and a plurality of keys, the keys being adapted for controlling water flow rate, water acidity and alkalinity, and water temperature, and the LCD panel being adapted for displaying values of the water flow rate, the water acidity and alkalinity, and the water temperature.
